(19) United States
(12) Patent Application Publication
(10) Pub. No.: US 2026/0293822 A1
(43) Pub. Date: Oct. 1, 2026

(54) Mechanical Lifting and Pulling Device with Stabilizing Base, Adjustable Clamping Mechanism, and Integrated Pulley System

(71) Applicant: Jay K. Martin, Madison, WI (US)

(72) Inventor: Jay K. Martin, Madison, WI (US)

(73) Assignee: Martin Product Design, Madison, WI (US)

(21) Appl. No.: 19/097,616

(22) Filed: Apr. 1, 2025

(51) Int. Cl. A01G 23/06; B66F 3/10

(52) U.S. Cl. CPC A01G 23/062; B66F 3/10; E02D 9/02; E04H 17/265

(57) ABSTRACT

The mechanical lifting and pulling device is designed to remove objects such as saplings, posts, and stumps from the ground with ease and precision. It features a lever-driven mechanism that provides mechanical advantage, adjustable clamping jaws for a secure grip, and foot pedals for enhanced stability during operation. To improve user-friendliness, the device includes ergonomic handles, a quick-release clamping system, non-slip foot pedals, and optional digital load sensors for real-time feedback. Lightweight materials such as aluminum and optional foldable components ensure portability, while weather-resistant coatings extend durability in outdoor environments. Safety features like locking clamps, load sensors, and an emergency stop button enhance control and user safety. The device is designed for both professional and consumer use, offering efficient and controlled removal of entrenched objects in various terrains and conditions. Optional motorization further reduces effort, making the device adaptable for heavy-duty applications.

### BACKGROUND OF THE INVENTION

### Technical Field

This invention relates generally to a mechanical lifting and pulling device. This invention relates more particularly to an apparatus/device for removing objects such as saplings, posts, and similar items from the ground using mechanical advantage.

This invention relates generally to apparatuses and devices for manually lifting and pulling objects from the ground or other surfaces. This method also can be used with fence posts, stumps, or similar objects. This invention relates more particularly to a portable lifting and pulling device to facilitate the removal of various objects from the ground while providing stability and control.

The present invention pertains to the field of mechanical devices and apparatuses used for manual lifting and pulling of objects from the ground. More specifically, the invention relates to devices designed for the extraction of saplings, fence posts, stumps, and similar objects using mechanical leverage, stabilization mechanisms, and gripping systems. The invention falls within the scope of U.S. patent classification definitions related to implements for removing plants or posts (Class 254/29) and lever-type tools (Class 81/15.9), which involve devices utilizing manual force to extract or lift objects from the ground. This field encompasses apparatuses designed to provide mechanical advantage, stability, and versatility for various pulling and lifting tasks in agricultural, landscaping, and construction environments.

The invention further incorporates features like clamping mechanisms, foot-operated controls, ratcheting gear systems, and braking systems, making it suitable for manual operation while ensuring safety and ease of use. This combination of elements classifies the invention under devices that enable efficient and controlled removal of objects that are embedded or rooted in the ground.

### Background Art

In the field of mechanical lifting and pulling devices, various tools and apparatuses have been developed for the extraction of objects such as saplings, fence posts, stumps, and other entrenched items from the ground. These tools primarily rely on manual leverage to generate sufficient force for removal. Among the most commonly cited examples are devices such as U.S. Pat. No. 9,468,137 (The Uprooter) and commercially available products like the Pullerbear and Brush Grubber. These tools utilize a basic combination of a lever arm and clamping mechanism designed to grip and pull objects from the ground.

However, despite their widespread use, these devices exhibit several limitations that hinder their efficiency, safety, and usability. Key issues in prior art include limited stability, lack of adjustable features, difficulty in applying controlled force, insufficient safety mechanisms, and challenges related to portability. These problems, which have persisted across various iterations of lifting and pulling devices, create significant inefficiencies for users, particularly in more demanding applications.

### Problems in Prior Art

Limited Stability and Ground Engagement: A fundamental issue with existing sapling and post pullers is the reliance on simple ground contact for stabilization. These devices are typically stabilized by pressing a baseplate or support arm against the ground, but this offers inadequate support, especially when operating on uneven or soft terrain. As a result, the device may tip or slip during operation, particularly when dealing with heavy or deeply entrenched objects. This instability forces users to exert additional effort to maintain balance, reducing the overall efficiency of the device and increasing the risk of accidents or injury.

Lack of Versatile, Adjustable Components: Many prior art devices are designed with rigid structures that are only suited for specific object sizes or shapes. For instance, the gripping mechanisms in these tools often have fixed dimensions or limited adjustability, which restricts their use to saplings or posts of certain diameters. This lack of versatility forces users to either purchase multiple tools for different tasks or to attempt inefficient workarounds, which can damage the device or the object being pulled.

Inconsistent Force Application and Lack of Control: One of the major shortcomings in existing sapling and post pullers is the inability to apply force incrementally or in a controlled manner. Most devices rely on continuous manual force applied through a lever arm, which can be difficult to control during strenuous pulling operations. Without the ability to gradually increase pulling force, users are more likely to experience slippage or uneven pulling, which not only reduces efficiency but also poses safety risks. Devices that lack mechanisms for controlling the application of force often require greater physical exertion and result in inconsistent performance.

Insufficient Safety Mechanisms: Safety is another critical area where prior art devices fall short. Most conventional sapling pullers do not include braking systems or similar features to prevent unintentional movement or release of the object being pulled. In the absence of such mechanisms, users must continuously exert force to keep the object in place. This introduces risks, particularly when dealing with heavy or deeply rooted objects, as the object may slip back or be released unexpectedly, causing potential injury to the operator.

Portability and Usability Issues: A significant number of devices in the prior art are bulky, heavy, and difficult to transport, limiting their use to specific locations or requiring significant effort to move them between jobs. While many existing pullers are effective for stationary use, their size and weight make them impractical for applications in remote or hard-to-reach areas. This lack of portability diminishes the overall practicality of these tools, particularly for professionals who require equipment that can be easily transported across different job sites.

### Improvements and Solutions Provided by the Applicant's Invention

The applicant's invention overcomes the limitations of prior art through a combination of innovative features and design elements that significantly enhance stability, versatility, safety, and portability. The invention represents a significant advancement in mechanical lifting and pulling devices, providing solutions to the long-standing problems associated with existing tools.

Enhanced Stability with Foot Pedals: The applicant's invention introduces the use of foot pedals to provide superior stability during operation. These pedals allow the user to securely anchor the device to the ground, offering a much more stable platform compared to devices that rely solely on ground contact. The foot pedals also enable the user to engage or disengage certain mechanisms of the device using foot pressure, thereby freeing the operator's hands and allowing for more precise control. This feature is particularly advantageous when working on uneven or soft terrain, where stability is crucial to effective operation.

Versatile Adjustable Components: To address the problem of rigidity in prior art, the applicant's invention features adjustable clamping mechanisms and a telescoping vertical structure, allowing the device to accommodate objects of various sizes and shapes. The clamping mechanism is designed to securely grip objects with irregular dimensions, ensuring a firm hold regardless of the size or shape of the sapling, post, or stump. The telescoping structure provides flexibility in height, making the device suitable for a wide range of lifting and pulling tasks. This versatility is a key differentiator from prior art, which is often limited to fixed dimensions and specific use cases.

Incremental Force Application via Ratchet Gear System: The invention incorporates a ratchet gear system that allows for incremental application of pulling force. This feature ensures that force is applied gradually, enabling the user to maintain control throughout the pulling process. The ratchet mechanism prevents slippage and holds the object in place after each stroke, allowing for safer, more controlled operation. This system is particularly beneficial when dealing with large or stubborn objects, as it reduces the physical exertion required and eliminates the risk of sudden, uncontrolled movements.

Integrated Mechanical and Holding Brakes for Enhanced Safety: Unlike prior art devices that lack sufficient safety features, the applicant's invention includes both a mechanical brake and a holding brake. The mechanical brake prevents unintentional movement once force has been applied, ensuring that the object remains securely clamped during operation. The holding brake maintains tension and prevents the object from slipping back or being released unintentionally. These safety mechanisms make the device far more secure and reliable than existing tools, reducing the risk of injury to the operator.

Compact, Lightweight, and Portable Design: The applicant's invention is designed with portability in mind. Despite its heavy-duty construction, the device is lightweight and compact, making it easy to transport to different locations. This is a significant improvement over bulky prior art devices, which are often difficult to move between job sites. The portability of the invention allows it to be used in remote areas, fields, forests, or any location where saplings, posts, or stumps need to be removed.

By addressing the major limitations of existing sapling pullers and lifting devices, the applicant's invention provides a safer, more versatile, and more efficient solution. It introduces novel features such as foot pedal stabilization, adjustable components, a ratchet gear system, and braking mechanisms, making it a substantial improvement over the prior art.

In light of the foregoing prior art, there is a need for a mechanical lifting and pulling device to better provide stability, safety, and versatility during the removal of objects from the ground, such as saplings, posts, and stumps.

### BRIEF SUMMARY OF THE INVENTION

The present invention relates to an improved mechanical lifting and pulling device designed to overcome the deficiencies in prior art by providing a safer, more stable, and versatile solution for the removal of objects such as saplings, fence posts, stumps, and other entrenched items from the ground. The device integrates multiple innovative features, offering enhanced functionality and ease of use for a wide range of applications in landscaping, agriculture, construction, and other outdoor environments.

A central feature of the invention is the incorporation of foot pedals, which serve to significantly improve the stability of the device during operation. Unlike conventional tools that rely solely on a baseplate for ground contact, the foot pedals allow the user to apply downward force to securely anchor the device, particularly on uneven, soft, or loose terrain. This design innovation prevents slippage or tipping, which is a common issue with prior devices, and ensures that the pulling or lifting action remains stable and controlled. The foot pedals may also function as an engagement mechanism for other parts of the device, allowing the user to operate certain features hands-free, which further enhances operational efficiency and safety.

Another key aspect of the invention is its adjustable clamping mechanism and telescoping vertical structure, which provide the device with the versatility needed to handle objects of various sizes, shapes, and conditions. The adjustable clamping mechanism is capable of securing non-uniform objects with a firm grip, making it suitable for pulling small saplings as well as larger posts or stumps. The telescoping vertical structure allows for height adjustments, giving users the flexibility to extend or shorten the device as needed, depending on the object being removed. This adaptability sets the invention apart from traditional tools that are limited to fixed dimensions and specific use cases, making it a much more functional tool for a variety of tasks.

The invention also introduces a ratchet gear system, which enables the incremental application of pulling or lifting force. This feature allows users to gradually apply force with each stroke of the lever, providing better control over the pulling process. The ratchet mechanism ensures that the object remains securely in place after each incremental pull, preventing slippage and rollback. This controlled force application reduces the physical strain on the operator and improves safety, as it minimizes the risk of sudden, uncontrolled movements that are common with continuous-force systems found in prior devices.

Safety is further enhanced by the integration of both a mechanical brake and a holding brake. The mechanical brake prevents the device from moving or releasing the object unintentionally once force is applied. This ensures that the object remains securely held in the clamping mechanism during the pulling or lifting operation, even if the operator pauses or releases the lever. The holding brake maintains tension on the object and prevents rollback or slippage, keeping the object securely in place after each incremental pull. These braking mechanisms are critical in ensuring user safety, particularly when dealing with heavier or more stubborn objects, as they prevent the object from falling back or being released unexpectedly during operation.

The compact and portable design of the device is another major advantage over traditional tools. While many prior devices are bulky, heavy, and difficult to transport, this invention is designed with portability in mind. Its lightweight construction allows it to be easily carried to different job sites, including remote or hard-to-reach areas where other devices would be impractical. Despite its portability, the device is made from heavy-duty materials, ensuring that it can withstand significant pulling forces and endure repeated use in challenging environments. This combination of portability and durability makes the device ideal for professionals and homeowners alike, who need a reliable tool that can be easily transported without sacrificing performance.

In addition to these functional benefits, the invention offers a range of ease-of-use features that enhance its practicality in the field. The ergonomic handle is designed for comfort, reducing operator fatigue during prolonged use. The quick-release mechanism allows the user to swiftly disengage the clamping system after the object has been removed from the ground, improving the efficiency of the operation and making the tool faster to deploy and reset. The chain mechanism is constructed from corrosion-resistant materials, ensuring that it remains operational even in wet or humid environments, further increasing the device's longevity.

According to a first aspect of the invention, there is a Mechanical Lifting and Pulling Device comprising: A lever or handle operable to generate a pulling or lifting force, providing mechanical advantage to facilitate removal of an object from a ground or surface. A base plate configured to stabilize the device during operation. A clamping mechanism connected to the base plate and configured for movement, adapted to engage saplings, posts, or similar objects. A pulley or wheel assembly integrated into the pulling mechanism to guide applied force and assist with managing a pulling chain. A screw jack integrated into the device, configured to incrementally raise or lower an object for precise control. Further features of the invention are disclosed in dependent aspects as follows:

According to a second aspect of the present invention, there is a Mechanical Lifting and Pulling Device in the form of a lifting/pulling device for stabilization during operation, comprising at least one foot pedal configured to engage or disengage the device. An advantage of the device is that the foot pedal enhances stability and allows for hands-free control during operation.

According to a third aspect of the present invention, there is a Mechanical Lifting and Pulling Device in the form of a lifting/pulling device for secure engagement of objects, comprising a front-mounted gripping system, adjustable to accommodate varying object sizes. An advantage of the device is that the adjustable gripping system ensures secure handling of different-sized objects, increasing its versatility.

According to a fourth aspect of the present invention, there is a Mechanical Lifting and Pulling Device in the form of a lifting/pulling device for incremental force application, comprising a lever connected to a ratchet gear system, allowing incremental pulling or lifting and preventing slippage. An advantage of the device is that the ratchet gear system provides precise control and safety, holding the load securely in place after each stroke.

According to a fifth aspect of the present invention, there is a Mechanical Lifting and Pulling Device in the form of a lifting/pulling device for maintaining tension, comprising a holding brake system to prevent unintentional release of an object during or after operation. An advantage of the device is that the holding brake ensures secure tension, preventing accidental disengagement and ensuring operational safety.

According to a sixth aspect of the present invention, there is a Mechanical Lifting and Pulling Device in the form of a lifting/pulling device for flexible object attachment, comprising an adjustable pulling chain connected to the clamping mechanism. An advantage of the device is that the adjustable pulling chain accommodates various object sizes, providing versatility and reliability.

According to a seventh aspect of the present invention, there is a Mechanical Lifting and Pulling Device in the form of a lifting/pulling device for height adjustment, comprising a vertical structure that is adjustable to accommodate objects of varying heights. An advantage of the device is its ability to handle objects at different heights, increasing flexibility for various lifting tasks.

According to an eighth aspect of the present invention, there is a Mechanical Lifting and Pulling Device in the form of a lifting/pulling device for heavy-duty applications, comprising construction from heavy-duty materials to withstand significant forces. An advantage of the device is that it is durable and reliable, suitable for lifting or pulling heavy objects under challenging conditions.

According to a ninth aspect of the present invention, there is a Mechanical Lifting and Pulling Device in the form of a lifting/pulling device for portability, comprising a compact and portable design for ease of transport and use in various locations. An advantage of the device is its lightweight and compact design, allowing for convenient transportation and use in different environments.

According to a tenth aspect of the present invention, there is a Mechanical Lifting and Pulling Device in the form of a motorized version, comprising an electric motor configured to drive the screw jack and the pulley or wheel assembly to automate a lifting or pulling operation. An advantage of the device is that automation reduces manual effort and enhances efficiency in demanding lifting and pulling applications.

According to an eleventh aspect of the present invention, there is a Mechanical Lifting and Pulling Device in the form of a motorized device further comprising a user interface for controlling the electric motor, allowing the user to adjust the speed and direction of the lifting or pulling operation. An advantage of the device is that the user interface provides greater precision and ease of control, making the device suitable for a range of lifting and pulling tasks.

According to a twelfth aspect of the present invention, there is a Mechanical Lifting and Pulling Device in the form of a lifting/pulling device for hands-free control, comprising a foot pedal configured to selectively engage or disengage the clamping mechanism. An advantage of the device is that hands-free operation improves user convenience and safety.

According to a thirteenth aspect of the present invention, there is a Mechanical Lifting and Pulling Device in the form of a lifting/pulling device for precise attachment, comprising a multi-jaw clamping configuration, each jaw independently adjustable. An advantage of the device is that the multi-jaw system securely holds irregularly shaped objects.

According to a fourteenth aspect of the present invention, there is a Mechanical Lifting and Pulling Device in the form of a lifting/pulling device for enhanced reach, comprising a telescoping vertical structure. An advantage of the device is that the telescoping structure increases reach and height, enabling use for a variety of tasks.

According to a fifteenth aspect of the present invention, there is a Mechanical Lifting and Pulling Device in the form of a lifting/pulling device for quick disengagement, comprising a quick-release mechanism integrated into the clamping system. An advantage of the device is that the quick-release mechanism allows for fast disengagement, improving operational efficiency.

According to a sixteenth aspect of the present invention, there is a Mechanical Lifting and Pulling Device in the form of a lifting/pulling device for durability, comprising a corrosion-resistant pulling chain. An advantage of the device is that the corrosion-resistant chain ensures longevity in wet or humid environments.

According to a seventeenth aspect of the present invention, there is a Mechanical Lifting and Pulling Device in the form of a lifting/pulling device for user comfort, comprising an ergonomic handle with cushioning. An advantage of the device is that the ergonomic handle reduces strain on the user during prolonged operation.

According to an eighteenth aspect of the present invention, there is a Mechanical Lifting and Pulling Device in the form of a lifting/pulling device for secure positioning, comprising a locking mechanism for the pulley system. An advantage of the device is that the locking mechanism prevents rollback, maintaining progress and safety.

According to a nineteenth aspect of the present invention, there is a Mechanical Lifting and Pulling Device in the form of a lifting/pulling device for stability on uneven terrain, comprising a pivoting base plate. An advantage of the device is that the pivoting base adjusts to rough surfaces, ensuring stability during operation.

According to a twentieth aspect of the present invention, there is a Mechanical Lifting and Pulling Device configured for use as a winch, comprising a vertical footpad arm, an integrated handle, and a lifting column in a horizontal position. An advantage of the device is that its winch configuration allows for precise control and secure operation in specialized lifting and pulling scenarios.

### Advantages of the Invention Over Prior Art

The present invention provides a number of significant advantages over existing mechanical lifting and pulling tools:

Enhanced Stability: The foot pedal system ensures superior stability on uneven or soft ground, addressing a common issue in prior art where devices are prone to slippage or tipping during use.

Greater Versatility: The adjustable clamping mechanism and telescoping vertical structure allow the device to be used on a variety of objects, from small saplings to larger posts, making it adaptable to different tasks and conditions.

Controlled Force Application: The ratchet gear system enables incremental force application, allowing users to exert pulling force in a controlled manner, preventing slippage and reducing physical strain.

Improved Safety: The mechanical and holding brakes ensure that the object being pulled remains securely in place, minimizing the risk of accidents or injury that could arise from sudden movements or unintentional release.

Portability and Durability: The device's lightweight yet durable construction makes it easy to transport while still capable of handling the significant forces required for challenging pulling tasks. Its compact design is ideal for use in remote locations where other devices may be impractical.

Ease of Use: The ergonomic handle, quick-release mechanism, and corrosion-resistant chain make the device easy and comfortable to use in various field conditions, improving the overall efficiency of the operation.

The present invention represents a significant advancement in mechanical lifting and pulling devices. By addressing the stability, safety, and versatility issues present in prior art, the invention offers a more reliable, efficient, and practical solution for removing objects from the ground. It is especially well-suited for applications where controlled, incremental force and enhanced safety are critical, and its portable design makes it an ideal tool for use in various field conditions. This combination of features makes the invention a substantial improvement over existing tools in this field.

The invention will now be described, by way of example only, with reference to the accompanying drawings in which:

### BRIEF DESCRIPTION OF THE SEVERAL VIEWS OF THE DRAWINGS

FIG. 1 is a perspective view of the mechanical lifting and pulling device with stabilizing base, adjustable clamping mechanism, and integrated pulley system in use according to the invention;

FIG. 2 is a underside perspective view of the mechanical lifting and pulling device with stabilizing base, adjustable clamping mechanism, and integrated pulley system according to the invention;

FIG. 3 is a perspective view of a second embodiment of the mechanical lifting and pulling device with stabilizing base, adjustable clamping mechanism, and integrated pulley system in use according to the invention; and

FIG. 4 is an underside perspective view of a second embodiment of the mechanical lifting and pulling device with stabilizing base, adjustable clamping mechanism, and integrated pulley system according to the invention.

### DETAILED DESCRIPTION OF THE INVENTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “one embodiment,” “an embodiment,” “an example embodiment,” etcetera, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Throughout this specification, the word “comprise,” or variations thereof such as “comprises” or “comprising,” will be understood to imply the inclusion of a stated element, integer or step, or group of elements integers or steps, but not the exclusion of any other element, integer or step, or group of elements, integers or steps.

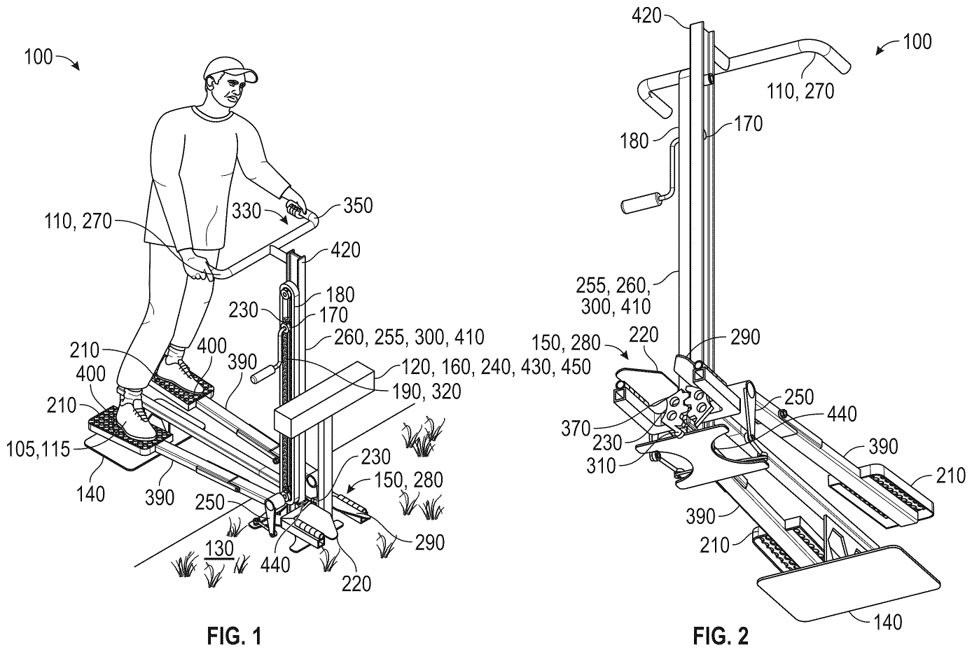

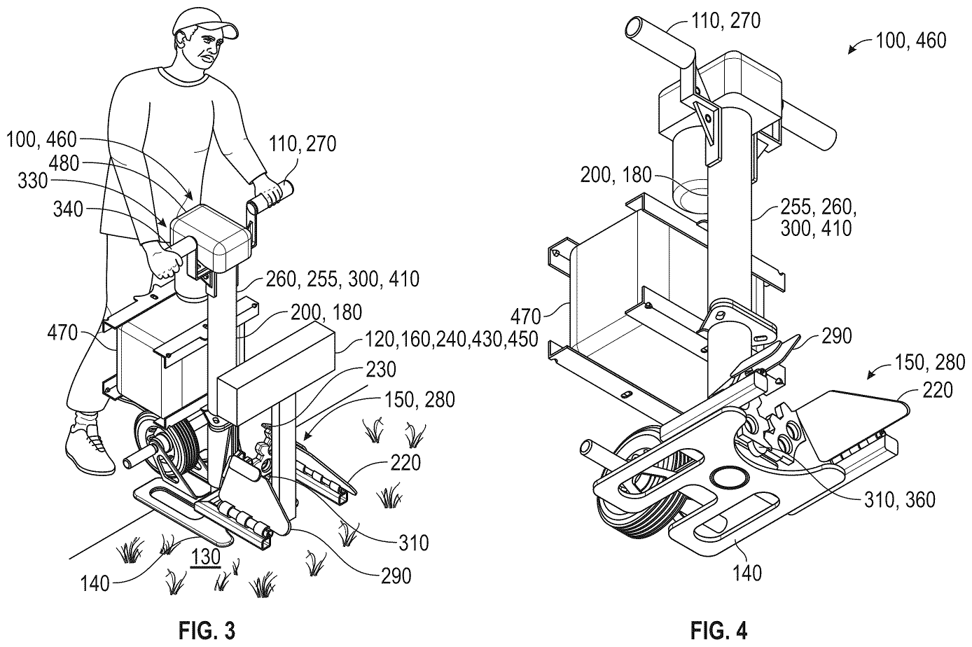

Index of Labelled Features in Figures. Features are listed in numeric order by Figure in numeric order. Referring to the Figures, there is shown in FIGS. 1, 2, 3, and 4 the following features:
Element 100 which is a mechanical lifting/pulling device.
Element 105 which is a foot of a user.
Element 110 which is a lever or a handle.
Element 115 which is a pulling force or a lifting force.
Element 120 which is an object.
Element 130 which is a ground or an other surface.
Element 140 which is a base plate.
Element 150 which is a clamping mechanism.
Element 160 which is a sapling, a post, or a similar object.
Element 170 which is a pulley or wheel assembly.
Element 180 which is a pulling mechanism.
Element 190 which is a pulling chain.
Element 200 which is a screw jack.
Element 210 which is a foot pedal.
Element 220 which is a front-mounted gripping system.
Element 230 which is a ratchet gear system.
Element 240 which is a load.
Element 250 which is a holding brake system.
Element 255 which is a lifting operation or a pulling operation.
Element 260 which is a vertical structure.
Element 270 which is a detachable handle or a detachable lever.
Element 280 which is a multi-jaw configuration.
Element 290 which is a jaw.
Element 300 which is a telescoping vertical structure.
Element 310 which is a quick-release mechanism.
Element 320 which is a corrosion-resistant material.
Element 330 which is an ergonomic handle design.
Element 340 which is a cushioning material.
Element 350 which is a contoured shape.
Element 360 which is a locking mechanism.
Element 370 which is a pivoting joint.
Element 390 which is a footpad arm.
Element 400 which is a footpad.
Element 410 which is a lifting column.
Element 420 which is a first end.
Element 430 which is a difficult to move or heavy object.
Element 440 which is a second end.
Element 450 which is a movable object.
Element 460 which is a motorized version.
Element 470 which is an electric motor.
Element 480 which is a user interface.

Not shown in the figures is the winch.

### How to Make the Invention

The construction of the mechanical lifting and pulling device requires a careful selection of durable materials and precise assembly of its key components. The process ensures that the device operates effectively and safely for a variety of lifting and pulling tasks. Below are detailed instructions on how to fabricate and assemble the components:

Base Plate Construction: The base plate forms the foundation of the device and must be made from a strong, durable material such as reinforced steel or high-strength aluminum to withstand the forces generated during operation. The base plate should be large enough to provide stability but not so heavy as to compromise portability. Precision-cut holes or slots should be machined into the base plate to allow for the attachment of the foot pedals, lever, and other components. These slots should be reinforced to ensure that they don't deform under pressure.

To further enhance stability, traction patterns or non-slip rubber pads can be added to the underside of the base plate. These will help maintain grip on various surfaces, including wet or uneven terrain, reducing the risk of slippage during operation.

Foot Pedal Assembly: The foot pedals are a critical feature that distinguishes this invention from prior art. Each foot pedal should be constructed from industrial-grade metal or high-strength polymer, designed to support the operator's weight and withstand repeated use. The pedals must be securely mounted to the base plate using hinged or pivoting joints to allow for smooth engagement and disengagement during operation.

The foot pedals may also include spring-loaded mechanisms that automatically return the pedals to their neutral position after each use. For added user comfort, the pedals can be fitted with ergonomically designed treads or cushioned surfaces to reduce fatigue during prolonged operation.

Lever/Handle Fabrication: The lever or handle provides the mechanical advantage necessary for pulling or lifting objects from the ground. The lever should be fabricated from high-strength tubular steel or aluminum alloy, which combines strength with lightweight properties. The length of the lever should be designed to maximize the mechanical advantage while ensuring that it remains easy to handle. Longer levers provide greater pulling power, while shorter ones are more portable and maneuverable.

The handle portion of the lever can be wrapped in rubberized or foam material to create an ergonomic grip, reducing user fatigue and improving comfort during operation. This handle can also incorporate a textured surface to enhance grip, especially in wet or humid conditions.

The lever should be attached to the base plate using a reinforced hinge or pivot joint, ensuring smooth rotation during operation. The pivot joint should be designed to support significant pulling forces without wearing down or becoming misaligned over time.

Clamping Mechanism Construction: The clamping mechanism is the core of the pulling device and must be robust enough to securely grip a variety of objects, from saplings to fence posts. The clamps should consist of adjustable metal jaws, constructed from hardened steel to resist bending or deformation during use. These jaws must be adjustable to accommodate objects of different diameters, allowing the device to adapt to a wide range of pulling tasks.

The clamping mechanism should be connected to the base plate via reinforced arms that extend forward. These arms should be designed to provide stability while allowing the jaws to apply a firm grip on the object. The adjustable jaws should be operated using threaded tensioning bolts or quick-adjust levers that allow the user to easily secure and release the object. For greater control, the clamping mechanism can be equipped with toothed grips or rubber inserts to increase traction and prevent slipping.

Ratchet Gear and Pulley System: The ratchet gear system allows the user to apply pulling force incrementally, making it easier to remove objects that are deeply entrenched in the ground. The ratchet gear should be constructed from hardened steel and integrated into the lever's pivot mechanism. This system should lock the lever in place after each pull, preventing the object from slipping back into the ground.

The pulley system is responsible for guiding the pulling chain or cable. It should be made from low-friction materials such as hardened steel or high-grade nylon, with precision-engineered bearings to ensure smooth operation. The pulley should be large enough to distribute the pulling force evenly, reducing wear on the chain and ensuring consistent performance.

Chain or Cable Installation: The pulling mechanism should consist of a high-tensile steel chain or braided cable, which connects the clamping mechanism to the lever arm. The chain must be able to withstand significant tensile forces without stretching or snapping. For added durability, the chain can be coated with a corrosion-resistant material, such as zinc or chrome, to protect it from rust and wear, especially in outdoor conditions.

The chain should be attached to the clamping mechanism using locking hooks or quick-release fasteners, allowing the user to easily secure and release the object. The chain should be threaded through the pulley system in such a way that it minimizes friction and maximizes the mechanical advantage provided by the lever.

Braking Systems: The mechanical brake is a critical safety feature designed to stop the lever or chain from moving unintentionally during operation. This brake can be a spring-loaded friction brake or a ratchet-based locking mechanism, and should be integrated into the lever's pivot point or the chain pulley system. The brake should be capable of holding the full weight of the object being pulled, preventing any rollback or slippage.

The holding brake operates in conjunction with the mechanical brake to maintain constant tension on the object being pulled. This brake should engage automatically as the ratchet gear locks in place, ensuring that the object doesn't slip back into the ground after each pull.

Telescoping Vertical Structure (Optional): The telescoping vertical structure provides additional versatility by allowing the user to adjust the height of the device. This structure can be made from collapsible steel or aluminum tubing and should include a locking mechanism that secures the structure at various heights. This feature is particularly useful for pulling taller objects or for applications that require a higher mechanical advantage.

The telescoping structure can be equipped with incremental height markers for easy adjustment, allowing the user to set the desired height quickly and accurately.

Final Assembly and Testing: After all components have been fabricated, they should be carefully assembled according to the design specifications. Bolts, rivets, and welding should be used to secure each component, ensuring that the device is robust and durable.

Once assembled, the device should undergo thorough testing to verify that all moving parts operate smoothly and that the clamping, ratchet, and braking systems function as intended. The device should be tested under various conditions, such as pulling saplings, fence posts, and stumps of different sizes, to ensure that it performs reliably in real-world applications.

### How to Use the Invention

The mechanical lifting and pulling device is designed for ease of use, even in difficult conditions. Below is an expanded step-by-step guide on how to operate the device safely and effectively:

Positioning the Device: Place the base plate of the device directly over or in front of the object you wish to remove (e.g., a sapling, post, or stump). Ensure that the base plate is flat against the ground to provide a stable foundation. On uneven or soft ground, adjust the position of the base plate to maximize stability.

Engaging the Foot Pedals: With the base plate in position, press down on the foot pedals to anchor the device securely to the ground. The foot pedals will help stabilize the device, preventing it from moving or tipping during the pulling process. On particularly difficult terrain, applying firm pressure on the pedals will ensure that the device remains stable and does not slip.

Adjusting the Clamping Mechanism: Open the adjustable jaws of the clamping mechanism to accommodate the diameter of the object you intend to pull. Position the jaws around the base of the sapling, post, or stump. Use the tensioning bolts or quick-adjust levers to tighten the jaws securely around the object. Ensure that the object is firmly clamped before proceeding, as a secure grip is critical for successful removal.

Using the Lever to Apply Force: Grasp the handle of the lever and begin pulling in a smooth, controlled motion. The ratchet gear system will allow you to apply incremental force, locking the lever in place after each stroke. This ensures that the object does not slip back into the ground between pulls. Apply steady pressure to avoid overexertion and to maintain full control of the device.

The pulley system will guide the chain, distributing the force evenly and making the pulling action smoother and more efficient. Continue pulling until the object begins to dislodge from the ground.

Maintaining Control with the Brakes: As the lever is pulled, the mechanical brake will engage, preventing the device from moving backward. This brake ensures that the object remains securely clamped during the operation. The holding brake will maintain tension on the object, preventing rollback and allowing for controlled removal. These brakes will ensure that the object is safely and steadily removed without sudden movements or slippage.

Incremental Pulling and Object Removal: Continue applying force incrementally using the ratchet gear system. As you pull, the object will gradually rise from the ground. For large or deeply entrenched objects, multiple strokes may be necessary.

The choice of materials for constructing the mechanical lifting and pulling device is critical for ensuring durability, safety, strength, and functionality. The following is a breakdown of the best materials to use for each key component of the invention, taking into consideration factors such as weight, strength, corrosion resistance, and ease of manufacturing:

### Base Plate Material Options:

Steel (Carbon Steel or Stainless Steel): Steel is ideal for the base plate due to its high strength and durability. Carbon steel is less expensive and offers excellent strength, while stainless steel provides superior corrosion resistance, making it suitable for outdoor and wet environments.

Aluminum Alloy: For a lighter alternative, aluminum alloy can be used. Aluminum is lightweight, resistant to corrosion, and strong enough for moderate loads. 6061 or 7075 aluminum alloys are common choices for high-strength, lightweight applications.

Best Choice: Stainless steel for maximum durability and corrosion resistance, or aluminum alloy for applications requiring portability and lightweight handling.

### Lever/Handle Material Options:

High-Strength Steel: For heavy-duty applications, high-strength carbon steel is preferred due to its excellent load-bearing capabilities. It can withstand high pulling forces without bending or deforming.

Aluminum Alloy (7075): If a lighter lever is desired, 7075 aluminum alloy is a great option, providing high tensile strength and being much lighter than steel, though slightly more expensive.

Best Choice: 7075 aluminum alloy for a balance of lightweight handling and strength, especially if the device will be transported often. For heavy-duty or industrial uses, high-strength steel is the best option for long-term durability.

### Clamping Mechanism Material Options:

Hardened Steel: The jaws of the clamping mechanism should be made from hardened steel to resist deformation and wear when gripping various objects. Steel also provides excellent tensile strength and toughness.

Titanium Alloy: For even better strength-to-weight ratio, titanium alloy could be used for the clamping jaws. Titanium offers excellent durability and corrosion resistance, but at a significantly higher cost.

Rubber Inserts or TPE (Thermoplastic Elastomer): To improve grip and prevent damage to softer materials being pulled, rubber inserts or TPE can be added to the jaws for extra traction and shock absorption.

Best Choice: Hardened steel for the jaws due to its toughness, combined with rubber inserts for added grip and protection for delicate objects.

### Ratchet Gear and Pulley System Material Options:

Hardened Steel or Case-Hardened Steel: The ratchet gear system should be made from hardened steel or case-hardened steel to ensure long-lasting performance under significant stress. These materials provide excellent wear resistance and high strength for the locking mechanism.

Nylon or Polycarbonate (for Pulley): The pulley system could be made from a strong, low-friction plastic like nylon or polycarbonate to reduce weight and ensure smooth chain or cable operation. These materials are durable, lightweight, and resistant to wear.

Best Choice: Hardened steel for the ratchet gear and nylon or polycarbonate for the pulley to provide a lightweight yet durable combination.

### Chain or Cable Material Options:

High-Tensile Galvanized Steel: Chains made from high-tensile galvanized steel are ideal for their strength and durability. The galvanized coating protects the steel from rust and corrosion, making it suitable for outdoor use.

Stainless Steel Chain: For even better corrosion resistance, stainless steel chains are an excellent option, especially in environments prone to moisture, such as coastal areas or near water.

Braided Steel Cable: Alternatively, a braided steel cable could be used instead of a chain. Braided cables offer flexibility, strength, and can be coated with a corrosion-resistant material like PVC or nylon.

Best Choice: High-tensile galvanized steel chain for general applications, or stainless steel for environments exposed to moisture or corrosive elements.

### Foot Pedals Material Options:

Steel (for heavy-duty models): Steel pedals offer excellent strength and stability but are heavier. For more intensive use, steel ensures that the foot pedals can bear significant pressure without bending.

Aluminum Alloy: For a lighter and more portable version, aluminum alloy pedals provide the needed strength without the added weight.

Thermoplastic Elastomer (TPE) Inserts: To improve grip and comfort, the pedals can include TPE or rubberized inserts for a non-slip surface, especially for use in wet conditions.

Best Choice: Aluminum alloy with TPE inserts for a lightweight, stable, and comfortable design. For heavy-duty use, steel pedals offer greater durability.

### Braking Systems Material Options:

Stainless Steel: The mechanical brake and holding brake components should be made from stainless steel to ensure durability and resistance to corrosion. Stainless steel provides excellent wear resistance and performs well under high mechanical loads.

Beryllium Copper (for springs): For any spring-loaded components, beryllium copper is an excellent choice due to its strength, durability, and resistance to fatigue. This material ensures that springs maintain their performance over long-term use.

Best Choice: Stainless steel for the braking systems and beryllium copper for springs to ensure longevity and consistent performance.

### Telescoping Vertical Structure (Optional) Material Options:

Aluminum Alloy (6061 or 7075): The telescoping structure should be made from 6061 or 7075 aluminum alloy for its lightweight properties and strength. Aluminum is corrosion-resistant and easy to transport, making it ideal for a collapsible design.

Carbon Fiber: For high-end or specialized applications, carbon fiber could be used to make the telescoping structure incredibly lightweight while offering exceptional tensile strength. Carbon fiber, however, comes at a higher cost.

Best Choice: Aluminum alloy (6061 or 7075) for most applications due to its strength, lightweight properties, and cost-effectiveness. Carbon fiber for premium or high-performance applications where weight reduction is critical.

### Ergonomic Handle Material Options:

Rubber or Thermoplastic Elastomer (TPE): The handle should be wrapped in rubber or TPE to provide a comfortable, non-slip grip that reduces user fatigue. These materials are soft, shock-absorbent, and maintain their properties in various weather conditions.

Foam-Grip Handle: For extra cushioning, a foam-grip handle can be used to provide additional comfort, particularly for prolonged use.

Best Choice: Rubber or TPE for general use, providing a durable and comfortable grip that works in various conditions.

### Fasteners and Connections Material Options:

Stainless Steel Bolts and Nuts: Fasteners should be made from stainless steel to resist rust and corrosion, ensuring a long-lasting connection between components.

Titanium Bolts (for lightweight models): Titanium bolts can be used for lightweight, high-performance models where both strength and corrosion resistance are essential, but weight needs to be minimized.

Best Choice: Stainless steel for general applications, providing durability and corrosion resistance at a reasonable cost.

Summary of Material Selection: Steel and hardened steel are excellent for components that need to bear heavy loads, such as the base plate, clamping mechanism, and ratchet gear.

Aluminum alloy (6061 or 7075) offers a great balance between strength and weight for components like the lever, telescoping structure, and foot pedals, making the device more portable. Nylon, polycarbonate, and TPE provide lightweight, low-friction solutions for the pulley system and grips, improving user comfort and operational efficiency. Stainless steel and galvanized steel are ideal for the chain, brake system, and fasteners, providing excellent corrosion resistance and durability, especially for outdoor use. This combination of materials ensures that the mechanical lifting and pulling device is strong, durable, and capable of performing in various conditions while being portable and easy to use.

Improving the mechanical lifting and pulling device can enhance its functionality, durability, user experience, and versatility for a wider range of applications. Below are several suggestions for potential improvements to the device:

Incorporating Hydraulic or Pneumatic Assistance: Improvement: Add a hydraulic or pneumatic assistance system to the lever or clamping mechanism. Benefit: Hydraulic or pneumatic systems would significantly reduce the physical effort required by the operator. These systems would provide additional pulling power, allowing the device to handle heavier loads or more deeply entrenched objects with minimal manual effort. Applications: This would be particularly useful for tasks requiring heavy lifting, such as pulling out large fence posts set in concrete or removing stumps with extensive root systems.

Interchangeable Clamping Mechanisms: Improvement: Design the device with interchangeable clamping jaws or attachments suited for different types of objects (e.g., wide jaws for large posts, spiked jaws for roots, or soft padded clamps for delicate objects). Benefit: This feature would make the device even more versatile, allowing it to securely handle a broader range of objects, from fragile items to irregularly shaped materials, without damaging them. Applications: Such modularity would be useful for industries like landscaping, construction, and tree care, where various object sizes and materials need to be handled.

Adjustable Foot Pedal Force: Improvement: Add an adjustable resistance feature to the foot pedals, allowing the user to control how much pressure is required to engage or stabilize the device. Benefit: This would provide more precision and control over the stabilization process, particularly on softer or uneven ground. Users could adjust the pressure to match the terrain and object being pulled. Applications: This improvement would be especially useful in areas with different ground conditions, such as mud, sand, or gravel.

Powered Winch Option: Improvement: Equip the device with an optional electric or battery-powered winch in place of the manual lever for pulling the chain or cable. Benefit: A powered winch would make the device suitable for heavier-duty tasks where manual operation would be too strenuous or time-consuming. It would also allow the operator to stand back while the device pulls, enhancing safety. Applications: This would be ideal for construction or industrial applications where removing heavy or deeply rooted objects is necessary, such as pulling large posts or buried cables.

Enhanced Ergonomics and Operator Comfort: Improvement: Introduce more ergonomic features, such as padded, adjustable handles, improved foot pedal angles, and spring-loaded mechanisms that reduce strain during repetitive use. Benefit: Reducing strain on the user's hands, feet, and body makes the device more comfortable to use for extended periods. This improvement would minimize fatigue and the risk of injury, particularly during repetitive operations. Applications: This would benefit users in agricultural and landscaping sectors who need to use the device over long periods.

Digital Load and Tension Sensors: Improvement: Integrate digital load sensors or a tension gauge into the device to measure the force being applied during each pull. Benefit: Users would have real-time feedback on how much force is being exerted, allowing them to avoid overloading the device or causing damage to the object being pulled. This feedback can also help users determine when to stop pulling to prevent breaking or damaging the object. Applications: This feature would be especially useful in professional settings where precision is key, such as archaeology, construction, or salvage work.

Self-Locking Clamps with Quick-Release Mechanism: Improvement: Modify the clamping mechanism to feature self-locking jaws that automatically adjust and grip the object when force is applied, with an integrated quick-release mechanism for easy disengagement. Benefit: This would save time during setup and operation, making it easier for users to clamp and release objects quickly. The self-locking clamps would automatically adapt to different object sizes, making the device more intuitive to use. Applications: This would be especially useful in fast-paced environments, such as construction or landscaping, where efficiency is critical.

Integrated Ground Anchors for Increased Stability: Improvement: Add deployable ground anchors that can be driven into the ground using a simple mechanism, providing additional stability during operation. Benefit: Ground anchors would provide extra support on particularly soft or slippery terrain, ensuring the device remains stable even under heavy loads. The anchors could be designed to retract or fold back into the device for easy transport. Applications: This would be useful in environments with loose soil or when pulling very large or deeply rooted objects where maximum stability is required.

Foldable or Collapsible Design: Improvement: Incorporate a foldable or collapsible frame that allows the device to be compactly stored and transported. Benefit: A foldable design would enhance portability, allowing users to carry the device in smaller vehicles or store it in compact spaces. The folding components could be reinforced to ensure that the device remains structurally sound when in use. Applications: This would be beneficial for contractors, arborists, or homeowners who need a portable tool that can be transported to different job sites with minimal hassle.

Improved Durability and Weather Resistance: Improvement: Use weather-resistant coatings and corrosion-proof materials, such as stainless steel, anodized aluminum, or treated polymers, for all critical components. Benefit: Increasing the weather resistance of the device would extend its lifespan, especially in outdoor applications where the device is exposed to moisture, dirt, or extreme temperatures. This would reduce maintenance needs and the risk of rust or wear over time. Applications: This would be ideal for professionals who need to use the device in harsh weather conditions or environments, such as outdoor construction, farming, or marine applications.

Customizable Leverage Ratios: Improvement: Implement a system that allows users to adjust the leverage ratio by changing the length or pivot point of the lever. Benefit: By allowing users to increase or decrease the leverage ratio, the device could be tailored to handle both lighter and heavier objects more efficiently. Higher leverage ratios would reduce the effort required for heavy-duty tasks, while lower ratios would offer more speed and flexibility for smaller jobs. Applications: This would be valuable in diverse industries where the types of objects being pulled can vary greatly, such as in landscaping, farming, or civil engineering.

Safety Shields and Guards: Improvement: Add safety shields or guards around the clamping mechanism and moving parts to protect the user from accidental contact during operation. Benefit: Safety shields would protect the operator from potential injuries caused by accidental slips or contact with the moving chain, pulley, or clamp. Shields made from lightweight but durable materials, such as polycarbonate, could enhance safety without adding significant weight to the device. Applications: This improvement would be particularly useful in construction sites, industrial environments, or public spaces where safety regulations require the protection of operators and bystanders.

Summary of Benefits from Improvements: By incorporating these enhancements, the mechanical lifting and pulling device can become more versatile, user-friendly, and durable across a wide range of applications. Key improvements such as hydraulic assistance, powered winches, and digital sensors would increase its efficiency for larger jobs, while foldable designs, ergonomic enhancements, and self-locking clamps would make it more practical and comfortable for everyday use. Whether for professional contractors, agricultural workers, or homeowners, these improvements would expand the device's functionality and appeal, making it suitable for a wider audience and variety of tasks.

While the primary use of the mechanical lifting and pulling device is to remove saplings, posts, and stumps from the ground, its versatile design and robust mechanical advantage make it suitable for a wide range of other applications. Below are several additional uses for the invention:

Fencing and Agricultural Posts Removal: The device can be used to pull out metal or wooden fence posts, which are often embedded in the ground with concrete bases or driven deep into the soil. Farmers, ranchers, and fencing contractors can use the device to efficiently remove old or damaged fence posts without the need for heavy machinery. The adjustable clamping mechanism accommodates various post sizes, and the incremental force application ensures controlled removal, even when posts are set in hardened ground.

Removing Tent Stakes or Anchors: In camping, construction, or temporary event setups, large tent stakes or ground anchors are often driven deeply into the soil. The mechanical lifting and pulling device can be used to easily extract these anchors, particularly when manual effort alone is insufficient. The foot pedal system and leverage offered by the device make pulling large stakes or anchors much easier, even in hard or rocky terrain.

Lifting Small Boulders or Heavy Objects: The device's clamping mechanism can be adapted to grip irregular objects like small boulders or rocks that are partially buried. With its mechanical advantage and stability features, the device can lift or shift these objects out of position, helping landscapers or construction workers to clear land or rearrange terrain. The ratchet system allows for gradual force application, preventing damage to surrounding areas.

Tree Root and Root Ball Removal: When cutting down trees or large bushes, the roots and root balls can be left behind in the soil, making it difficult to plant new items or clear land. The device can be used to grip and pull up tree roots, leveraging the mechanical advantage to extract them from the ground with minimal disturbance to the surrounding soil. The adjustable jaws can be positioned to grasp root sections or taproots directly, making the removal of stubborn roots much easier.

Heavy Equipment Assistance: On farms, construction sites, or remote locations, it is often necessary to assist heavy equipment or vehicles that become stuck in mud, sand, or uneven terrain. The device can be used to help reposition heavy machinery by gripping parts of the equipment, such as towing points, and applying a lifting or pulling force. This can help free machinery that might otherwise require larger equipment for recovery.

Clearing Fence Lines or Agricultural Debris: In agricultural environments, clearing debris such as old wire fencing, vines, or brush can be time-consuming when done manually. The device can be adapted to pull up tangled vegetation, broken fencing material, or other obstructions from the ground. By attaching the clamping mechanism to the debris and using the lever system, users can clear these areas more efficiently.

Vehicle Recovery: The mechanical lifting and pulling device can also be used in off-road vehicle recovery scenarios, particularly for smaller vehicles such as ATVs, dirt bikes, or motorcycles that get stuck in mud, snow, or sand. The device can act as a manual winch to pull the vehicle free by attaching the clamping mechanism or chain to a fixed anchor point, like a tree or rock, and incrementally applying force using the lever.

Boat Dock or Marine Anchor Removal: The device can be used to pull up boat docks, marine anchors, or other structures that are embedded in the soil underwater or in shallow water. For example, removing docks or pilings at the end of the season can be simplified by the device's adjustable clamping mechanism, which can grip these structures securely and allow the user to incrementally lift them out of the ground or waterbed.

Assisting with Erosion Control Projects: In erosion control, structures like stakes, sandbags, and posts are often placed to stabilize soil. The device can be employed to pull out these items after their usefulness has passed. For instance, after sandbags or silt fences have been installed to control water flow, they may need to be removed. The lifting and pulling device can securely grip these items, enabling quick and efficient removal even when the ground has settled tightly around them.

Salvaging Buried Objects: The device is highly useful for salvaging buried objects, such as pipes, old equipment, or buried metal items. Archaeologists, treasure hunters, or surveyors working on old construction sites may encounter items partially or fully buried underground. This invention can assist in pulling up or shifting these items out of the soil without causing damage to the objects or the surrounding area.

Removing Tree Stands or Hunting Blinds: For hunters, removing portable tree stands or hunting blinds that have been left in place for extended periods can be challenging when they become stuck in trees or embedded in the ground. The device can be used to safely extract tree stands by clamping onto structural elements of the stand and applying controlled force to free it.

Removing Landscape Timbers and Garden Borders: The device is also ideal for removing landscape timbers, garden borders, or retaining walls that have been buried or set in place for extended periods. Gardeners or landscapers who need to remove or reposition these elements can use the device to grip and pull them out without damaging nearby plants or structures.

Assisting in Urban and Suburban Tree Removal Projects: In urban and suburban settings, where machinery access can be limited, the mechanical lifting and pulling device offers a compact, portable solution for tree and shrub removal. It is ideal for working in tight spaces where large machinery can't operate, such as small backyards, gardens, or along sidewalks. Landscapers and arborists can use the device to remove plants and saplings efficiently while minimizing disruption to the surrounding area.

Advantages in Broader Applications: Portability and Ease of Use: Since the device is compact and portable, it can be easily transported to remote locations or areas with limited access. This makes it particularly useful for environments such as forests, agricultural fields, off-road sites, or suburban areas where heavy machinery may not be feasible. Adaptability: The adjustable clamping mechanism and telescoping structure make the device adaptable to various tasks, whether it's pulling out small plants or large wooden posts. This flexibility allows it to be employed in multiple industries, including agriculture, landscaping, construction, and outdoor recreational activities. Safety and Precision: The ability to apply force incrementally with the ratchet system ensures controlled removal of objects, which is particularly useful when precision is required to avoid damage to surrounding structures or materials.

The mechanical lifting and pulling device is not limited to sapling and post removal but can be applied to a wide range of tasks across various industries, including agriculture, construction, landscaping, and vehicle recovery. Its versatility, combined with its portability and ease of use, makes it a valuable tool for numerous applications, from extracting objects embedded in the ground to assisting in recovery and demolition projects.

In a preferred embodiment of the present invention, there is a Mechanical Lifting and Pulling Device comprising a lever or handle, a base plate, a clamping mechanism, a pulley or wheel assembly, and a screw jack. The lever or handle is operable to generate a pulling or lifting force, providing mechanical advantage to facilitate the removal of an object from a ground or surface. The base plate is configured to stabilize the device during operation. The clamping mechanism, connected to the base plate and configured for movement, is adapted to engage saplings, posts, or similar objects. The pulley or wheel assembly is integrated into the pulling mechanism to guide applied force and assist with managing a pulling chain. The screw jack is configured to incrementally raise or lower an object for precise control.

In an alternate embodiment of the present invention, there is a Mechanical Lifting and Pulling Device in the form of a lifting/pulling device for stabilization during operation, comprising at least one foot pedal configured to engage or disengage the device. The foot pedal enhances stability and allows for hands-free control during operation.

In an alternate embodiment of the present invention, there is a Mechanical Lifting and Pulling Device in the form of a lifting/pulling device for secure engagement of objects, comprising a front-mounted gripping system, adjustable to accommodate varying object sizes. The adjustable gripping system ensures secure handling of different-sized objects, increasing its versatility.

In an alternate embodiment of the present invention, there is a Mechanical Lifting and Pulling Device in the form of a lifting/pulling device for incremental force application, comprising a lever connected to a ratchet gear system, allowing incremental pulling or lifting and preventing slippage. The ratchet gear system provides precise control and safety, holding the load securely in place after each stroke.

In an alternate embodiment of the present invention, there is a Mechanical Lifting and Pulling Device in the form of a lifting/pulling device for maintaining tension, comprising a holding brake system to prevent unintentional release of an object during or after operation. The holding brake ensures secure tension, preventing accidental disengagement and ensuring operational safety.

In an alternate embodiment of the present invention, there is a Mechanical Lifting and Pulling Device in the form of a lifting/pulling device for flexible object attachment, comprising an adjustable pulling chain connected to the clamping mechanism. The adjustable pulling chain accommodates various object sizes, providing versatility and reliability.

In an alternate embodiment of the present invention, there is a Mechanical Lifting and Pulling Device in the form of a lifting/pulling device for height adjustment, comprising a vertical structure that is adjustable to accommodate objects of varying heights. The adjustable structure allows handling of objects at different heights, increasing flexibility for various lifting tasks.

In an alternate embodiment of the present invention, there is a Mechanical Lifting and Pulling Device in the form of a lifting/pulling device for heavy-duty applications, comprising construction from heavy-duty materials to withstand significant forces. The device is durable and reliable, suitable for lifting or pulling heavy objects under challenging conditions.

In an alternate embodiment of the present invention, there is a Mechanical Lifting and Pulling Device in the form of a lifting/pulling device for portability, comprising a compact and portable design for ease of transport and use in various locations. The lightweight and compact design allows for convenient transportation and use in different environments.

In an alternate embodiment of the present invention, there is a Mechanical Lifting and Pulling Device in the form of a motorized version, comprising an electric motor configured to drive the screw jack and the pulley or wheel assembly to automate a lifting or pulling operation. Automation reduces manual effort and enhances efficiency in demanding lifting and pulling applications.

In an alternate embodiment of the present invention, there is a Mechanical Lifting and Pulling Device in the form of a motorized device further comprising a user interface for controlling the electric motor, allowing the user to adjust the speed and direction of the lifting or pulling operation. The user interface provides greater precision and ease of control, making the device suitable for a range of lifting and pulling tasks.

In an alternate embodiment of the present invention, there is a Mechanical Lifting and Pulling Device in the form of a lifting/pulling device for hands-free control, comprising a foot pedal configured to selectively engage or disengage the clamping mechanism. Hands-free operation improves user convenience and safety.

In an alternate embodiment of the present invention, there is a Mechanical Lifting and Pulling Device in the form of a lifting/pulling device for precise attachment, comprising a multi-jaw clamping configuration, each jaw independently adjustable. The multi-jaw system securely holds irregularly shaped objects.

In an alternate embodiment of the present invention, there is a Mechanical Lifting and Pulling Device in the form of a lifting/pulling device for enhanced reach, comprising a telescoping vertical structure. The telescoping structure increases reach and height, enabling use for a variety of tasks.

In an alternate embodiment of the present invention, there is a Mechanical Lifting and Pulling Device in the form of a lifting/pulling device for quick disengagement, comprising a quick-release mechanism integrated into the clamping system. The quick-release mechanism allows for fast disengagement, improving operational efficiency.

In an alternate embodiment of the present invention, there is a Mechanical Lifting and Pulling Device in the form of a lifting/pulling device for durability, comprising a corrosion-resistant pulling chain. The corrosion-resistant chain ensures longevity in wet or humid environments.

In an alternate embodiment of the present invention, there is a Mechanical Lifting and Pulling Device in the form of a lifting/pulling device for user comfort, comprising an ergonomic handle with cushioning. The ergonomic handle reduces strain on the user during prolonged operation.

In an alternate embodiment of the present invention, there is a Mechanical Lifting and Pulling Device in the form of a lifting/pulling device for secure positioning, comprising a locking mechanism for the pulley system. The locking mechanism prevents rollback, maintaining progress and safety.

In an alternate embodiment of the present invention, there is a Mechanical Lifting and Pulling Device in the form of a lifting/pulling device for stability on uneven terrain, comprising a pivoting base plate. The pivoting base adjusts to rough surfaces, ensuring stability during operation.

In an alternate embodiment of the present invention, there is a Mechanical Lifting and Pulling Device configured for use as a winch, comprising a vertical footpad arm, an integrated handle, and a lifting column in a horizontal position. An advantage of the device is that its winch configuration allows for precise control and secure operation in specialized lifting and pulling scenarios in various horizontal and vertical positions.

The mechanical lifting and pulling device is actuated by a lever mechanism that provides a mechanical advantage, allowing objects such as saplings, posts, and stumps to be lifted or pulled from the ground with ease. The device features an operatively connected clamping mechanism that adjusts relative to the base plate, ensuring a secure grip on objects of varying sizes. Designed for rapid deployment, the device integrates an adjustable pulling chain and a ratchet gear system, enabling incremental application of force while preventing loss of progress during operation. The provision of a foot pedal system enhances stability by locking the device into position, reducing user fatigue and ensuring controlled force application.

To accommodate different terrains, the base plate of the mechanical lifting and pulling device includes a pivoting joint, allowing for stability on an inclined or rough surface while maintaining a secure grip on the object being removed. The device's locking mechanism secures the pulley system after each pulling stroke, ensuring that the object remains lifted without rollback. Additionally, independently adjustable clamping jaws allow for the secure engagement of irregularly shaped objects, while the telescoping vertical structure offers extended reach. With its lockable storage position and corrosion-resistant materials, the device boasts an extended operational lifespan, making it a reliable solution for heavy-duty lifting and pulling applications.

The sapling puller invention differs from the prior art in several key ways, addressing limitations of existing sapling pullers and providing enhanced functionality, control, and versatility. Here are the distinguishing aspects of this invention:

Footpads/Foot Pedals for Stabilization and Control: Unlike prior art, which typically relies solely on the user's physical balance and ground contact for stability, this sapling puller includes footpads or foot pedals. These pedals allow the user to stabilize the device more effectively during operation. The foot pedals may also engage or disengage mechanisms, which is a unique feature that improves the ease of operation and reduces the need for external force to keep the device steady.

Mechanical and Holding Brakes for Safety and Precision: Previous sapling pullers often lack advanced braking systems. This invention incorporates both a mechanical brake and a holding brake. The mechanical brake prevents unwanted movement once force is applied, ensuring that the object remains securely clamped during the pulling process. The holding brake maintains tension and keeps the object in position between pulling strokes. These features enhance control, prevent backsliding, and improve safety, especially when removing large or deeply rooted objects.

Ratchet Gear System for Incremental Force Application: Traditional sapling pullers require continuous force application, which can be difficult to control. This invention introduces a ratchet gear system that allows incremental application of force. Users can gradually increase the pulling force with each stroke, and the ratchet mechanism holds the object in place after each stroke, preventing slippage and reducing the effort required to remove larger or more stubborn saplings or posts.

Pulley or Wheel System for Force Management: In prior designs, force is often applied directly through the lever without any guiding system. This invention includes a pulley or wheel system that manages the chain used for pulling. The pulley helps guide and distribute the force more evenly, which improves efficiency and minimizes the user's effort by reducing friction and providing smoother operation.

Adjustable Components for Versatility: While some prior sapling pullers are designed for specific object sizes or conditions, this device features adjustable components such as the vertical structure and clamping mechanism. These adjustments make the device versatile, allowing it to handle objects of varying sizes, such as small saplings, medium-sized trees, fence posts, and similar objects. The adjustability provides greater flexibility compared to more rigid, size-specific designs in the prior art.

Compact and Portable Design: Many prior art sapling pullers are bulky and difficult to transport, which limits their usability in different locations. This invention emphasizes a compact and portable design, making it easy to carry and deploy in different areas, whether in a forest, field, or backyard setting. Its portability distinguishes it from heavier, less mobile options available in the market.

Heavy-Duty Construction for Durability: While some existing pullers may handle moderate loads, this sapling puller's heavy-duty construction enables it to withstand significant pulling forces. The durable materials and reinforced design allow it to perform consistently in challenging conditions, handling not only saplings but also posts and stumps that require higher force for extraction.

The claims focus on the general concept of a mechanical lifting/pulling device, expanding its applicability beyond saplings to encompass other objects such as posts, stumps, or similar items that require lifting or pulling. This broadens the scope of the claims while maintaining the key inventive elements.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1-30. (canceled)

31. A motorized lifting/pulling device comprising:
a base frame including a base plate having a ground-contacting traction surface;
an electric motor;
a motorized screw lifting assembly driven by said electric motor and comprising a rotatable lead screw and a traveling nut constrained for linear motion along a guide, said traveling nut being operatively coupled to apply a lifting or pulling force to an object;
a clamping assembly mounted forward on said base frame and comprising a pair of opposed jaws movable between open and closed positions to grip said object, said clamping assembly further including:
(i) a jaw actuator operatively coupled to said pair of opposed jaws; and
(ii) a mechanical quick-release cam lever that opens said pair of opposed jaws independently of electrical power;
a controller operatively coupled to said electric motor, said jaw actuator, and a user interface, said controller being configured to execute a pull cycle in which said controller:
(i) commands said jaw actuator to close said pair of opposed jaws until a threshold grip force is detected by a load sensor associated with said clamping assembly,
(ii) commands said electric motor to rotate said rotatable lead screw to incrementally lift or pull said object, and
(iii) halts said electric motor upon detection of at least one of a torque limit, a displacement setpoint, or an instability condition indicated by a sensor data including load/tension measurements;
said user interface comprising discrete controls for speed, direction, and mode selection and indicators of measured load and system status; and
at least one transport aid affixed to said base frame to facilitate transport.

32. The device of claim 31, wherein said jaw actuator comprises a powered actuator selected from an electric linear actuator, a hydraulic cylinder, or a pneumatic cylinder.

33. The device of claim 31, wherein said load sensor comprises at least one of:
a force sensor disposed between a jaw and said base frame; or
a motor-current sensor calibrated to indicate said threshold grip force.

34. The device of claim 31, further comprising a sensor configured to detect instability, wherein said sensor data comprises at least load/tension data measured by said load sensor and optionally one or more of a vibration, a tilt, or an acceleration.

35. The device of claim 31, wherein said controller is further configured to automatically reopen said pair of opposed jaws after said pull cycle completes and said electric motor is stopped.

36. The device of claim 31, wherein said user interface includes a selectable automated extraction program that sequentially closes said pair of opposed jaws to said threshold grip force, drives said lead screw for a programmed displacement, pauses to reassess conditions based on said sensor data, and repeats until a completion condition is met.

37. The device of claim 31, wherein said base plate is coupled to said base frame by an adjustable pivot joint enabling stable operation on uneven or inclined surfaces.

38. The device of claim 31, further comprising a rechargeable battery pack providing power to said electric motor and said controller.

39. The device of claim 31, further comprising a back-drive-resisting drivetrain configured to hold said traveling nut in position when said electric motor is de-energized.

40. The device of claim 31, wherein said motorized screw lifting assembly includes a gear-reduction unit between said electric motor and said lead screw to increase output torque and positional precision.

41. The device of claim 31, wherein said mechanical quick-release cam lever is mechanically coupled to said pair of opposed jaws by links such that actuation of said mechanical quick-release cam lever simultaneously separates said pair of opposed jaws.

42. The device of claim 31, wherein contact faces of said pair of opposed jaws include replaceable high-friction inserts.

43. The device of claim 31, wherein said user interface further comprises a display configured to present real-time values of said load/tension measurements and optionally one or more of motor torque or device tilt angle.

44. The device of claim 31, wherein said transport aid is retractable between a transport position and an operating position in which said base plate fully contacts a ground.

45. The device of claim 31, wherein said controller is configured to stop said electric motor and command said jaw actuator to reopen upon detecting an excessive rate of change in said load/tension measurements indicative of instability.
